(19) United States
(12) Patent Application Publication
(10) Pub. No.: US 2025/0308040 A1
(43) Pub. Date: Oct. 2, 2025

(54) Using Previous Best Fit as Initialiser

(71) Applicant: Ag Leader Technology, Inc., Ames, IA (US)

(72) Inventors: Josue Calderon, Apex, NC (US); Trent Anagnostopoulos, Ankeny, IA (US)

(73) Assignee: Ag Leader Technology, Inc., Ames, IA (US)

(21) Appl. No.: 19/077,898

(22) Filed: Mar. 12, 2025

Related U.S. Application Data
(60) Provisional application No. 63/571,869, filed on Mar. 29, 2024.

(51) Int. Cl. G06T 7/246; A01B 69/04; G06T 3/18

(52) U.S. Cl. CPC G06T 7/248; A01B 69/008; G06T 3/18; G06T 2207/10016; G06T 2207/30188; G06T 2207/30252

(57) ABSTRACT

A method for tracking line-based features across sequential image frames includes obtaining a first image frame from an imaging device, identifying, in the first image frame, a plurality of line-based features, wherein the line-based features comprise straight or curved lines, generating a first mathematical representation of the line-based features in the first image frame, storing parameters defining the first mathematical representation, obtaining a second image frame from the imaging device, utilizing the stored parameters of the first mathematical representation to establish an initial search region for identifying the line-based features in the second image frame, identifying, in the second image frame, the plurality of line-based features based on the initial search region, and generating a second mathematical representation of the line-based features in the second image frame.

### RELATED APPLICATIONS

This application claims priority to U.S. provisional patent application No. 63/571,869, filed Mar. 29, 2024 and entitled “Using Previous Best Fit as Initialiser” which is hereby incorporated by reference in its entirety.

### FIELD OF THE INVENTION

The present disclosure relates to systems and methods for visual tracking of line-based features in sequential images. More particularly, but not exclusively, the present disclosure relates to using previous best fit as an initialiser for efficiently tracking line-based features such as crop rows across sequential image frames in agricultural applications.

### BACKGROUND

Although the background is discussed primarily in the context of a vehicle such as an agricultural vehicle moving through a field or over a field (such as in the case of aerial vehicles such as UAVs) where there are crop rows present, it is to be understood that the present disclosure has other applications and therefore, the present disclosure is not to be limited to this specific application.

The present disclosure relates to methods and systems to visually track a specific row or series of rows of crops based on the location of those same rows as found in previous frames. The same method can also be used to find rows of crops or individual plants adjacent to a lane identified in previous frames. This method reduces the likelihood of lane-jumping and helps to avoid issues with outliers, noisy data points, or invalid image frames that might degrade tracking accuracy.

When a camera is mounted onto a moving vehicle and affixed such that the viewing axis is aligned with and centered relative to the body of the vehicle, the central vertical axis of an image from the camera corresponds to the vehicle's direction of travel when driving straight. However, as soon as the vehicle begins to turn, since the camera is statically mounted onto the body of the vehicle, the direction of travel of the vehicle will no longer correspond to the central axis of the image. FIG. 1 illustrates a vehicle in the form of a tractor 10. The tractor has a plurality of different cameras 12 mounted in different forward facing locations of the tractor. OF course, cameras may be otherwise mounted. Regardless of which of these locations is used, the same problems are incurred.

Based on the camera being aligned with the body of the vehicle and centered relative thereto, it follows that, if one were to try and visually steer between two rows of crops, the lane aligned with the center of the front axle of the vehicle will not always correspond with the lane in the center of an image from a mounted camera. When the vehicle is traveling straight, the lane is typically centered in the camera's field of view. However, when the vehicle turns, the lane's visual alignment within the camera frame shifts, creating discrepancies between actual vehicle travel paths and perceived lane positioning within the image.

This can lead to a phenomena which is sometimes referred to as lane jumping wherein the target lane which one would wish to steer down is visually lost due to some external factors and an adjacent lane is mistakenly seen as the lane that should be followed. Examples of such external factors include, without limitation, missing or downed plants, weeds, changes in ambient lighting, or other factors. This error may create various issues. For example, the vehicle would no longer be following the desired lane or series of crop rows which could lead to misapplication of fertilizer or improperly harvested corn (depending on the season and the operation). A further example is the risk of damaging crops due to them being run over by the vehicle's wheels. Neither issue is desirable.

FIGS. 2A-2D show a series of four different images from a camera mounted on a vehicle. It is shown that the location of the desired lane appears to shift, even for the first two images (FIG. 2A, FIG. 2B), with the vehicle driving along a straight section of the pass and even more so along the gentle left (FIG. 2C) and right (FIG. 2D) curves. For more aggressive turns, one would see that the lane would appear to shift even further from the expected location at the center of the camera frame. Even though these four images (FIG. 2A-2D) are based on a vehicle steering along a gently curving guidance line, it should be understood that consistently relying on the lane or expecting individual crop rows to always appear in the same region of the camera image would be neither reasonable nor feasible.

Additionally, even in the case that the crop rows and the corresponding lane between them were straight, if there were significant amounts of weeds or other vegetation in the image, it would be not only possible but probable that some plants may be mischaracterized as being part of a crop when they are not. This mischaracterization may lead to improper identification of the lane between rows and, in the event that guidance commands were being generated to steer down this lane, improper guidance commands resulting in sub-par vehicle control and degrading the user experience as well as the efficiency of the operation (e.g., spraying or harvesting).

Therefore, what is needed are methods and systems for tracking line-based features such as crop rows across sequential image frames that can maintain accurate identification of the desired lane despite issues such as, without limitation, vehicle turning, varying camera perspectives, and environmental factors like weeds or missing plants, allowing for accurate navigation along crop rows even during turns or in challenging field conditions.

### SUMMARY

Therefore, it is a primary object feature, or advantage of the present disclosure to improve over the state of the art.

It is a further object, feature, or advantage to reduce the computational processing load required for tracking line-based features across sequential image frames.

It is a still further object, feature, or advantage to provide a tracking methodology that maintains continuity despite variations in image quality between frames.

Another object, feature, or advantage is to enable more efficient utilization of processing resources by targeting analysis to specific regions of interest based on historical data.

Yet another object, feature, or advantage is to improve the robustness of visual tracking systems in environments with variable lighting conditions.

It is a further object, feature, or advantage to distinguish between relevant linear features and visual noise or anomalies that might otherwise disrupt tracking.

It is a still further object, feature, or advantage to maintain accurate tracking of linear features during relative movement between the imaging device and the tracked features.

Another object, feature, or advantage is to provide a methodology for bridging momentary gaps in visual data without requiring system reinitialization.

Yet another object, feature, or advantage is to enable linear feature tracking on lower-power computing systems through improved computational efficiency.

It is a further object, feature, or advantage to maintain tracking accuracy during perspective changes as either the camera or the tracked features move.

It is a still further object, feature, or advantage to provide a technical solution for tracking features in environments where conventional full-frame analysis methods would be prohibitively resource-intensive.

Another object, feature, or advantage is to reduce memory requirements by storing mathematical representations of features rather than raw image data.

Yet another object, feature, or advantage is to enable continuous operation of tracking systems in industrial environments with intermittent visual obstructions.

It is a further object, feature, or advantage to improve the response time of systems that depend on real-time linear feature tracking.

It is a still further object, feature, or advantage to provide a tracking methodology applicable to various forms of linear infrastructure including roads, railways, and pipelines.

It is an object, feature, or advantage of the present disclosure to provide a method for visually tracking crop rows based on their location in previous frames.

It is a further object, feature, or advantage of the present disclosure to reduce lane-jumping in visual guidance systems for agricultural vehicles.

It is a still further object, feature, or advantage to maintain tracking continuity when encountering frames with missing or damaged crop rows.

Another object, feature, or advantage is to reject flyer points, noisy data, or invalid frames while maintaining guidance capability.

Yet another object, feature, or advantage is to track the position of crop rows relative to a moving vehicle during turns when the rows no longer align with the central axis of the camera.

It is a further object, feature, or advantage to provide a method for identifying and ignoring weeds that would otherwise degrade the quality of lane tracking.

It is a still further object, feature, or advantage to improve computational efficiency by using previous frame data as an initial position estimate for current frame analysis.

Another object, feature, or advantage is to filter best-fit line data across multiple frames to increase robustness to temporary visual obstructions or lighting variations.

Yet another object, feature, or advantage is to enable tracking of multiple parallel lanes simultaneously within the same image frame.

It is a further object, feature, or advantage to maintain curvature parameters for tracked rows to better follow curved crop rows during turns.

It is a still further object, feature, or advantage to determine optimal camera frame rates that ensure tracking continuity based on vehicle speed and turning radius.

Another object, feature, or advantage is to integrate with external guidance data from previous operations such as planting.

Yet another object, feature, or advantage is to distinguish between crop plants and weeds based on their relative position to tracked rows.

It is a further object, feature, or advantage to enable automated cataloging of weed positions for future treatment or removal.

It is a still further object, feature, or advantage to maintain tracking capability during transitions between different lighting conditions in agricultural fields.

Another object, feature, or advantage is to provide a methodology that works with various imaging technologies including color cameras, depth cameras, lidar, and ultrasonic sensors.

Yet another object, feature, or advantage is to apply perspective transformation when beneficial without requiring such transformation for the method to function.

It is a further object, feature, or advantage to reduce computational load by avoiding exhaustive searches of each new frame.

It is a still further object, feature, or advantage to improve agricultural vehicle steering precision when operating between crop rows.

Another object, feature, or advantage is to enable continuous operation even when some frames must be skipped due to quality issues. It is a further object, feature, or advantage to enable robust visual tracking in agricultural environments with varied plant growth stages.

It is a still further object, feature, or advantage to maintain tracking accuracy during changes in ground elevation or terrain irregularities.

Another object, feature, or advantage is to reduce the computational hardware requirements for effective row tracking systems.

Yet another object, feature, or advantage is to provide tracking capabilities that function effectively in dusty or partially obscured field conditions.

It is a further object, feature, or advantage to enable the system to adapt to changes in row spacing across different sections of a field.

It is a still further object, feature, or advantage to maintain accurate tracking when transitioning between different crop varieties with varying visual characteristics.

Another object, feature, or advantage is to provide a tracking methodology that performs consistently across different times of day and corresponding lighting conditions.

Yet another object, feature, or advantage is to enable precise navigation in fields with irregular planting patterns or partial crop emergence.

It is a further object, feature, or advantage to reduce operator fatigue by maintaining consistent automated guidance between crop rows.

It is a still further object, feature, or advantage to improve agricultural efficiency by enabling precise operations in narrower row spacings than would be practical with manual guidance.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

According to another aspect, a method for tracking crop rows in agricultural environments is provided. The method includes obtaining a first image frame from an imaging device mounted on a vehicle, identifying a plurality of crop rows in the first image frame, generating a first best fit line representing a lane between adjacent crop rows in the first image frame, and storing parameters defining the first best fit line. The method further includes obtaining a second image frame from the imaging device, utilizing the stored parameters of the first best fit line to establish an initial location for identifying crop rows in the second image frame, identifying the plurality of crop rows in the second image frame based on the initial location, and generating a second best fit line representing the lane between adjacent crop rows in the second image frame. The parameters defining the first best fit line may include coefficients of a polynomial equation. The method may include tracking multiple lanes simultaneously by generating separate best fit lines for each lane visible in the image frames. The method may include applying a perspective warp to at least one of the first image frame and the second image frame to generate a bird's eye view of the crop rows. The method may include controlling steering of the vehicle based on the second best fit line to navigate the vehicle along the lane between adjacent crop rows.

According to yet another aspect, a system for visual tracking of crop rows in agricultural environments is provided. The system includes a vehicle con to traverse an agricultural field, an imaging device mounted on the vehicle and configured to capture sequential image frames of crop rows, and a processor communicatively coupled to the imaging device. The processor is configured to obtain a first image frame from the imaging device, identify a plurality of crop rows in the first image frame, generate a first best fit line representing a lane between adjacent crop rows in the first image frame, store parameters defining the first best fit line, obtain a second image frame from the imaging device, utilize the stored parameters of the first best fit line to establish an initial location for identifying crop rows in the second image frame, identify the plurality of crop rows in the second image frame based on the initial location, and generate a second best fit line representing the lane between adjacent crop rows in the second image frame. The system also includes a steering control system configured to guide the vehicle based on the second best fit line. The imaging device may include at least one of a color camera, a depth camera, a lidar sensor, or an ultrasonic sensor. The processor may be configured to filter best fit line data across multiple sequential image frames to improve robustness to missing or degraded frames. The processor may be configured to maintain tracking of the crop rows during vehicle turns by compensating for changes in the apparent position of crop rows within the image frames. The system may include a spraying system configured to apply treatment to vegetation elements identified as weeds based on their position relative to the best fit line.

According to another aspect, a method for visually guiding an agricultural vehicle along crop rows is provided. The method includes capturing a first image frame of an agricultural field with an imaging device rigidly mounted on an agricultural vehicle. The method further includes identifying, in the first image frame, crop rows positioned adjacent to a lane navigable by the vehicle. The method further includes generating a first best fit line representing the lane between the identified crop rows, wherein the first best fit line is defined by parameters corresponding to a mathematical representation of the lane. The method further includes storing the parameters defining the first best fit line, capturing a second image frame subsequent to the first image frame, and using the stored parameters from the first best fit line to establish an initial search area in the second image frame, identifying crop rows within the initial search area in the second image frame, generating a second best fit line representing the lane based on the identified crop rows in the second image frame, and automatically steering the agricultural vehicle along the lane based upon the second best fit line.

According to yet another aspect, a visual guidance system for an agricultural vehicle is provided. The system includes an agricultural vehicle configured for travel within an agricultural field having rows of crops, an imaging device mounted on the agricultural vehicle configured to capture sequential image frames depicting the rows of crops, and a processor. The processor configured to: identify crop rows in a first captured image frame, generate and store parameters defining a best fit line representing a guidance lane positioned between identified crop rows, utilize the stored parameters to initialize the identification of crop rows in a subsequent captured image frame, and generate an updated best fit line based upon crop rows identified using the initial search parameters from the stored best fit line. The system further includes a steering control system configured to automatically guide the agricultural vehicle along the lane defined by the updated best fit line to enable precise navigation between adjacent crop rows.

According to another aspect, a method of identifying and cataloging weed locations in an agricultural field includes capturing a first image frame using an imaging device mounted on an agricultural vehicle traveling through an agricultural field, identifying rows of crops in the first image frame, generating and storing parameters defining a first best fit line representing a lane positioned between adjacent crop rows, capturing a second, subsequent image frame, utilizing the stored parameters from the first image frame to identify crop rows and a lane between the crop rows in the second image frame, detecting vegetation features in the second image frame positioned at a predetermined threshold distance or greater from the identified rows of crops, classifying the detected vegetation features as weeds based on their distance relative to the identified crop rows, and storing navigation coordinates corresponding to positions of the classified weeds for future weed management operations.

According to another aspect, a system is configured to identify and record weed locations within an agricultural environment. The system includes an agricultural vehicle (such as a ground-based vehicle or aerial vehicle) configured to traverse crop rows, an imaging device attached to the agricultural vehicle for capturing sequential image frames of the agricultural field, and a processing system communicatively coupled to the imaging device, configured to: identify crop rows within captured image frames, generate mathematical representations of lanes between adjacent crop rows, detect vegetation located at distances exceeding a predefined threshold from the identified crop rows, classify such vegetation as weeds based solely on spatial relationship criteria, determine navigation coordinates corresponding to locations of the classified weeds, and store the navigation coordinates in a database accessible for subsequent weed management actions.

### BRIEF DESCRIPTION OF THE DRAWINGS

Illustrated aspects of the disclosure are described in detail below with reference to the attached drawing FIGs, which are incorporated by reference herein.

FIG. 1 is a pictorial representation of a vehicle in the form of a tractor with cameras mounted in different locations.

FIG. 2A is a photographic image within a field with a target lane to be steered along overlaying the image. FIG. 2A shows the target lane at the start of a pass.

FIG. 2B is a photographic image within a field with a target lane to be steered along overlaying the image. FIG. 2B shows a straight section.

FIG. 2C is a photographic image within a field with a target lane to be steered along overlaying the image. FIG. 2C shows the target lane with a gentle left curve.

FIG. 2D is a photographic image within a field with a target lane to be steered along overlaying the image. FIG. 2D shows the target lane with a gentle right curve.

FIG. 3 illustrates process flow for each new image.

FIGS. 4A, 4B, 4C, 4D illustrate best fit lines from a base image overlaid on a next frame at different frame rates for the camera. FIG. 4A illustrates a 5 Hz frame rate. FIG. 4B shows the same base image but with a best fit line from the next frame at a frame rate of 30 Hz. FIG. 4C shows the same base image but with a best fit line from the next frame at a frame rate of 10 Hz. FIG. 4D shows the same base image but with a best fit line from the next frame at a frame of 5 Hz.

FIG. 5 is a photographic representation showing three crop rows being tracked (with dots shown in the plant rows) and corresponding lanes also shown using dots.

FIG. 6 illustrates distances of vegetation from the best fit line for the previous frame for the closest rows, second closest, and third closest rows.

FIG. 7A illustrates line fit quality when a weed is ignored and a line remains straight.

FIG. 7B illustrates line fit quality when a weed is used in generating the line and thus the line curves to the right.

FIG. 8 is a block diagram illustrating one example of a system configured to track line-based features across sequential image frames.

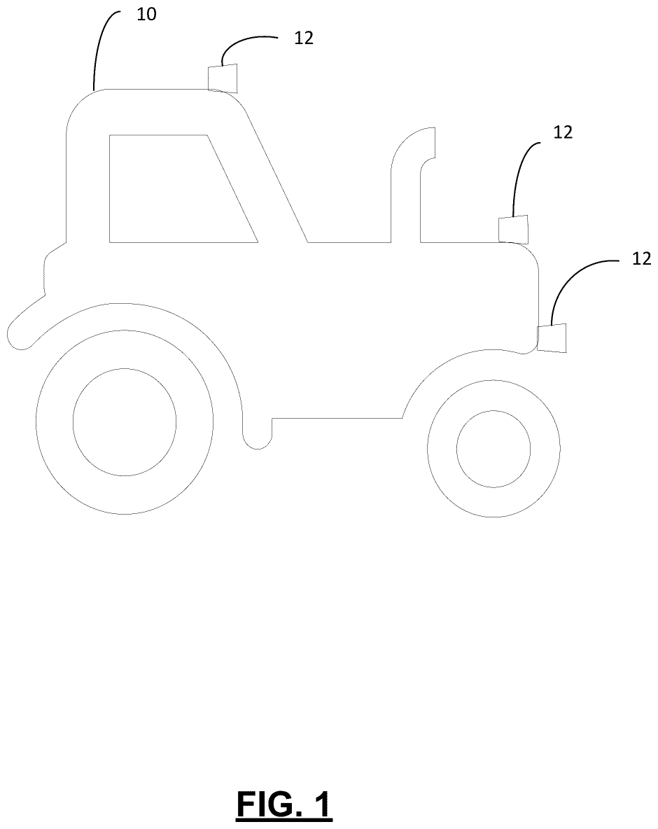

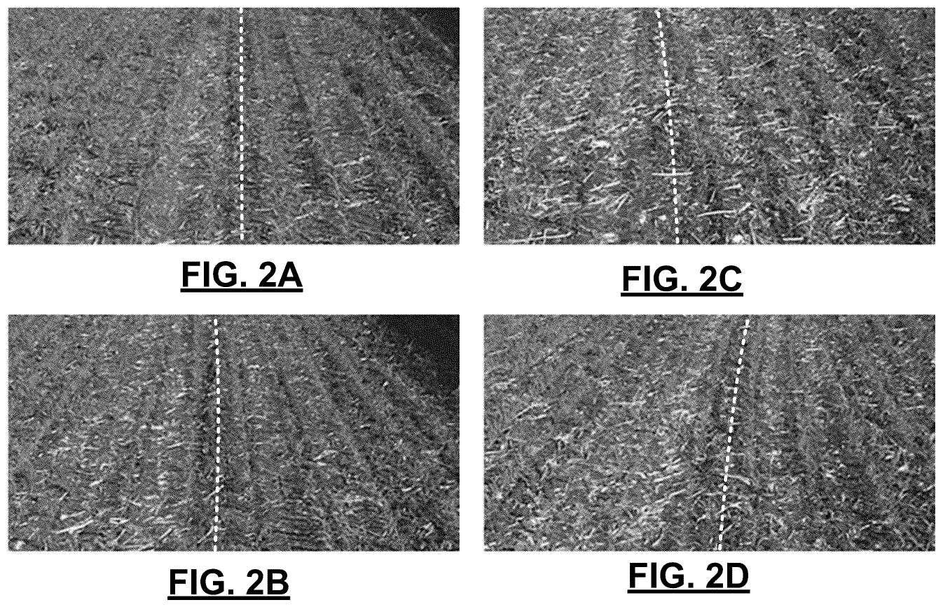

### DETAILED DESCRIPTION

As previously explained, there are problems with tracking line-based features across image frames. As used herein, the term “line-based” explicitly encompasses both linear and curvilinear features, including straight lines, curved lines, polynomial curves, spline curves, piecewise linear segments, Fourier series approximations, and any other mathematically defined representation of linear or curvilinear structures suitable for visual tracking across sequential image frames.

Although such a problem can occur in various applications or environments, one particular environment where the problem occurs is in agricultural such as in vision-based guidance systems for operating agricultural equipment within a row crop field. In such an environment it may be advantageous to visually track a specific row or series of rows of crops based on the location of those same rows as found in previous frames. However, it may be problematic to do so because crop rows and the lanes between them may be curved, weeds or other vegetation may be present, and lanes can be easily misidentified which limits the ability to provide proper guidance commands to track rows. Depending upon the particular implementation, it may also be advantageous to identify rows of crops or individual plants adjacent to a lane identified in previous frames.

To compensate for this, it is helpful to be able to identify and track the two (or more) rows alongside the desired lane or the lane itself, that is to be followed. Toward this end, keeping a history of the location of the lane to be followed between frames (as provided by the camera) is beneficial. Where a history is kept, and the frame rate of the camera (or other imaging device) is sufficiently high, the image would not significantly shift between frames, thus the previous estimated location for the rows or the lane between the rows may be used as an initial guess for the location of the same features in the next frame.

Furthermore, if the lane to be followed is curving, then it makes sense to not only track the position of the lane from frame to frame but to track some kind of parameters corresponding to the type of turn. For example, these might be the path curvature or, if some polynomial line fit was used, the coefficients for a best fit curve would be stored. These parameters serve as references for initializing feature localization in subsequent frames.

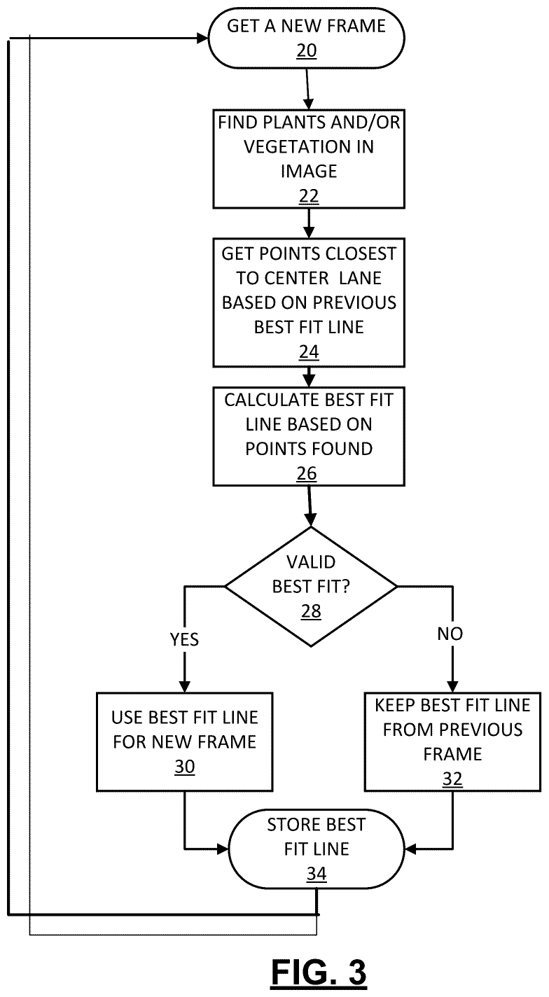

FIG. 3 depicts the iterative process by which subsequent frames utilize best fit line data from prior frames to identify plants that should be used to generate the best fit line for each new frame.

It should be clear that using sequential frames would be ideal as the best fit line for one frame, whilst being a good approximation or starting point for the next frame may not be as helpful or even applicable if multiple frames are skipped. Similarly, the assumption is that the camera's frame rate is fast enough that storing the best fit line from a prior frame would be beneficial (i.e., the vehicle has not traveled so far as to make the best fit line from the previous frame exit the space between the rows adjacent to the lane being tracked).

In step 20, a new frame is obtained. The frame may be an image acquired from a camera or other imaging device. Next in step 22, plants and/or vegetation in the image are found. Next in step 24, points closest to a center lane are obtained based on a previous best fit line. Then in step 26, a best fit line is calculated based on the points found in the image. In step 28, a determination is made as to whether the best fit is valid. If it is, then in step 30, it is determined that the best fit line will be used for a new frame (the next frame). If it is not then the decision is made to keep the best line from the previous frame in step 32. Regardless of whether the best fit line comes from the new frame or previous frame, the best fit line is stored in step 34, the process returns to step 20 for the next frame.

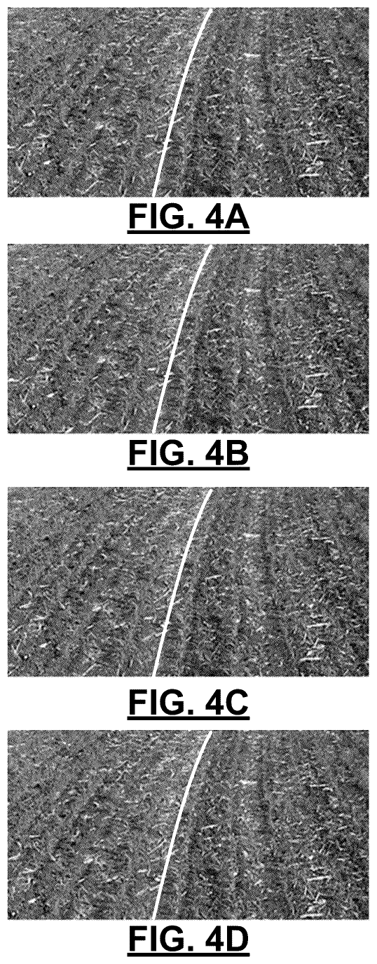

FIGS. 4A, 4B, 4C, and 4D illustrate the effects of different frame rates of a camera on the best fit line. The camera and its frame rate should be selected such that the best fit line from a given image is still pertinent for the next image. For the examples shown, the best fit line from the base image shown in FIG. 4A is still very close to the center of the lane for the 30 Hz camera rate. FIG. 4B is also very close to the center of the lane for the 10 Hz camera rate. As shown in FIG. 4C, the best fit line is getting close to the crop row on the right of the lane at 5 Hz. Thus, if the camera were run at 5 Hz along this route and a frame were dropped, had to be ignored, the curve were slightly sharper, or the vehicle were traveling more quickly, then at that frame rate, this method could have resulted in lane jumping as the best fit line for the base image may have resided in between rows of crops which are not the ones we wish to use as a reference. The effective frame rate required to maintain tracking continuity is dependent on vehicle speed, turning radius, image resolution, and the algorithm's tolerance for positional deviation between sequential frames. However, the faster the frame rate, the higher the processing requirements involved in a system.

Travel speed may vary based on the type of equipment, type of field operations being performed, crop stage, field conditions, operator preference, and other conditions. For example, for spraying operations, speeds may generally be around 10 to 18 mph but may be higher or lower.

It is also noted that due to the nature of the movement in the camera, other methods used to track the central lane would, likely, also fail in low hertz rate scenarios. Thus, the methodology is advantageous.

An added benefit from this method shown in FIG. 4A to FIG. 4D is that the best fit line would still provide a beneficial starting point all the way up to 5 Hz and certainly at the faster 10 Hz rate. Thus, if the camera was run at 30 Hz, and frames were dropped or deemed to be too noisy to be used the best fit line could safely be kept and utilized for the following frame. This would hold true even in the event that multiple, sequential frames were not used. This robustness to adverse conditions is a significant benefit of this methodology.

This process may be extended to not just use the best fit line from a singular image but to filter the best fit lines across multiple data frames. If the frame rate is high enough, we can assume that the equation which defines the best fit line for a lane would not change drastically. Thus, we may filter either the data points or the defining parameters of the line (e.g. for an nₜₕ order polynomial, those would be the coefficients). As used herein, the term “parameters” may refer to numerical values, coefficients, or data points defining the mathematical representation of line-based features. Such parameters include, but are not limited to, polynomial coefficients, spline control points, Fourier series terms, curvature measures, or linear regression coefficients.

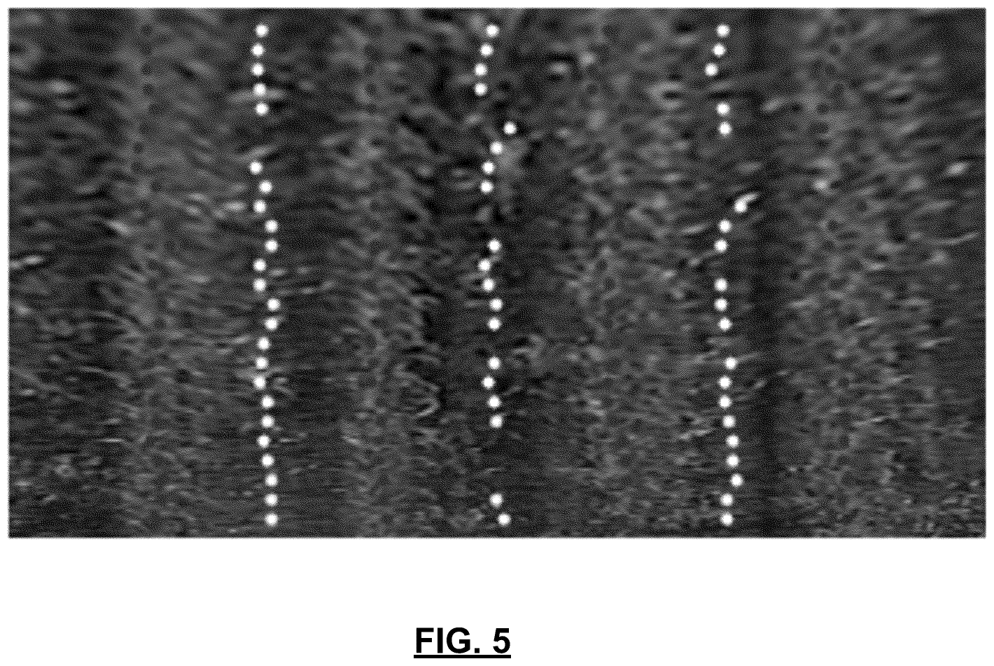

It should also be understood that this process is not restricted to tracking a singular lane but may be used to track a plurality of lanes within the camera's view, even including every lane within the camera's view. An example where three lanes are visible and tracked can be seen in FIG. 5. Note that while the lanes are shown using white dots, applying a simple curve fit to each set of white dot (representing each of the three lanes) allows the three resultant best fit lines to be applied to the subsequent frame.

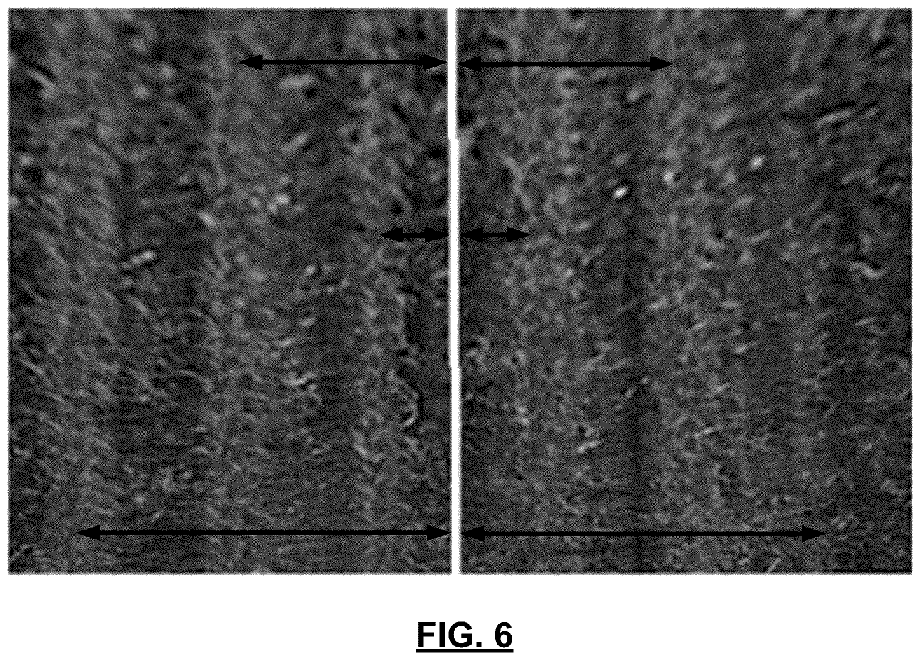

Similarly, one may choose to track the distances from multiple rows to the center of one (or more lanes). This is shown in FIG. 6 where the distance of the points to the best fit line are indicated for the three closest rows of crops, on each side of the desired lane. Note that, for the sake of clarity, only three sets of dots are shown to be measured with the overlaid arrows, but the measurement would apply to all the points indicating vegetation. Examples of methods of finding vegetation are disclosed in U.S. patent application Ser. No. 19/041,825, filed Jan. 30, 2025, hereby incorporated by reference in its entirety, including the column-based identification of crop rows described therein and measured or offset toward the center of the lane and further including the neighboring row methodology described therein. Of course, other methods may be used.

As previously disclosed herein the benefits of this method for guidance lines generated from visual data include resilience to missing, noisy, or degraded quality. There is an additional advantage when dealing with guidance lines or generating a best fit line for the visually identified vegetation data in that the best fit line for new data should be similar to the best fit line for the previous data as previously discussed herein. Thus, after the first line is generated (through a calibration, initial guess, or user selected value), there is no need to search through every possible solution for a best fit as the solution should be close to the previous one. This may provide significant computational savings, depending on the methodology used to find/compute the best fit line. For example, if a gradient descent search were used to numerically approximate the coefficients of an nth order polynomial, starting close to the true values may save several iterations in the process. The computational savings may be even more drastic for more complicated styles of curves (e.g., Fourier series). It should be further understood that the present disclosure includes both images with a perspective warp applied and images without in order to further demonstrate the versatility of the methodology discussed herein. For example, some images have a perspective warp applied to a given region of interest in front of the vehicle (such as those shown in FIG. 5 and FIG. 6), with the perspective warp simulating a bird's eye view of the crop rows by compensating for the vanishing point. Other images do not have the perspective warp applied (such as those shown in FIG. 4). Although using a perspective warp may be preferred by an operator or for diagnostic purposes, it is not strictly necessary for this method to be utilized.

### Applications for Weeds

According to another aspect of the present disclosure, the previous frame's best fit line may be used as a way to identify and ignore weeds that would otherwise degrade the quality of the line fit and, subsequently, the steering performance of a vehicle relying on that data.

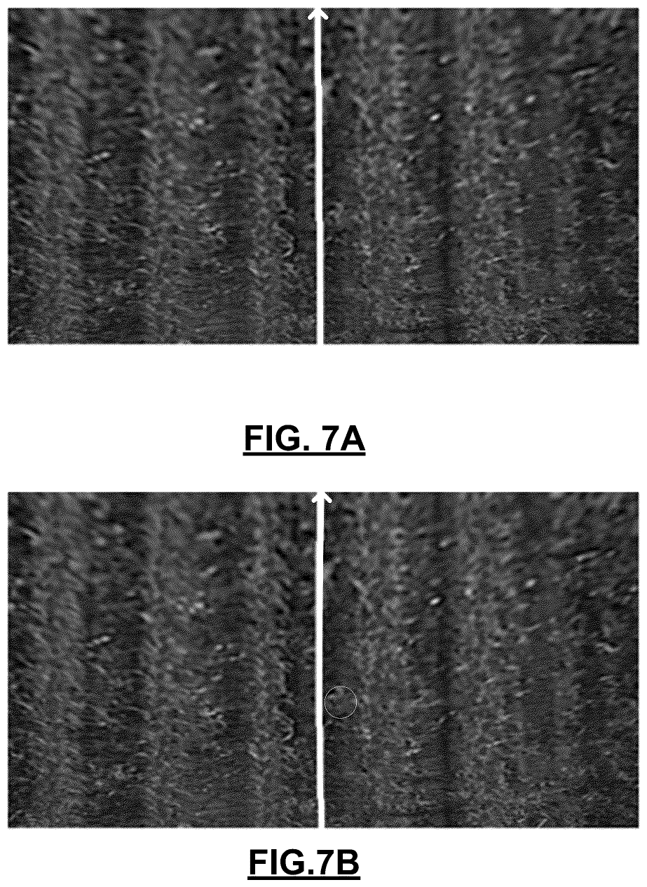

FIG. 7 illustrates two curve fits where there is a grouping of weeds in the middle of the lane to be steered and the effect that ignoring that vegetation has on the quality of the curve fit for that frame. Whist the change is somewhat subtle (hence the visualization using arrows to indicate that the heading veers off to the right when the weeds are not ignored versus staying straight ahead when they are properly ignored), there is a definite difference in the resultant best fit line. Note that the grouping of weeds was identified using the prior curve fit data by validating that said vegetation was too close to the center of the lane to be part of the crop row and must therefore be weeds. As an extension, if the number of weeds were deemed to be too high, one could choose to ignore the current frame and wait for a better one (as previously discussed).

The ability to identify weeds in an image and ignore during guidance line generation may be extended in various ways. For example, the weed's location in navigation coordinates (such as GPS coordinates) may be stored such as disclosed in U.S. patent application Ser. No. 19/057,707, hereby incorporated by reference in its entirety. Thus, once the weed's location is stored in navigation coordinates it may be targeted for future removal. It is also contemplated that a weed killer may be directly applied if a camera is mounted on a sprayer capable of applying weed killer. Similarly, if the camera is mounted on an agricultural vehicle which provides for weed removal to be performed using alternative means such as electrocution or laser heating, then the weed may be removed otherwise.

It should be understood that although the imaging device shown in examples has been a color camera, the methods shown and described may be used with other types of image devices, including, without limitation, depth cameras, lidar, ultrasonic devices or others. Images collected from such devices may be used to calculate a best fit line and apply it to subsequent data.

According to another aspect, an available guidance line may be used. For example, if there are planting guidance lines available for crop rows then such lines may be imported for performing spraying operations. The guidance lines may be converted into camera space such as by using the inverse of the method described in U.S. patent application Ser. No. 19/057,707.

Note that, whilst only the case of color cameras have been discussed, this method would work just as well for any image collection device (depth camera, lidar, ultrasonics, etc.) from which a best fit line could be calculated and applied to subsequent data. It should also be noted that, in the event that a guidance line is available and provided to the system (e.g. planting guidance lines imported into a sprayer), then this guidance line could be converted into camera space by using the inverse of the method discussed in Projecting Pixels onto Terrain and that guidance line could be used as the expected/previous best fit line for the location of the row. Doing so would allow for more accurate assessment of weeds vs crops since the guidance line should be close to the reality on the ground. It also allow for the system to easily identify how far off the visual row is from the expected row (likely due to planter drift) and apply the necessary corrections for the vehicle to be aligned with the center of the row.

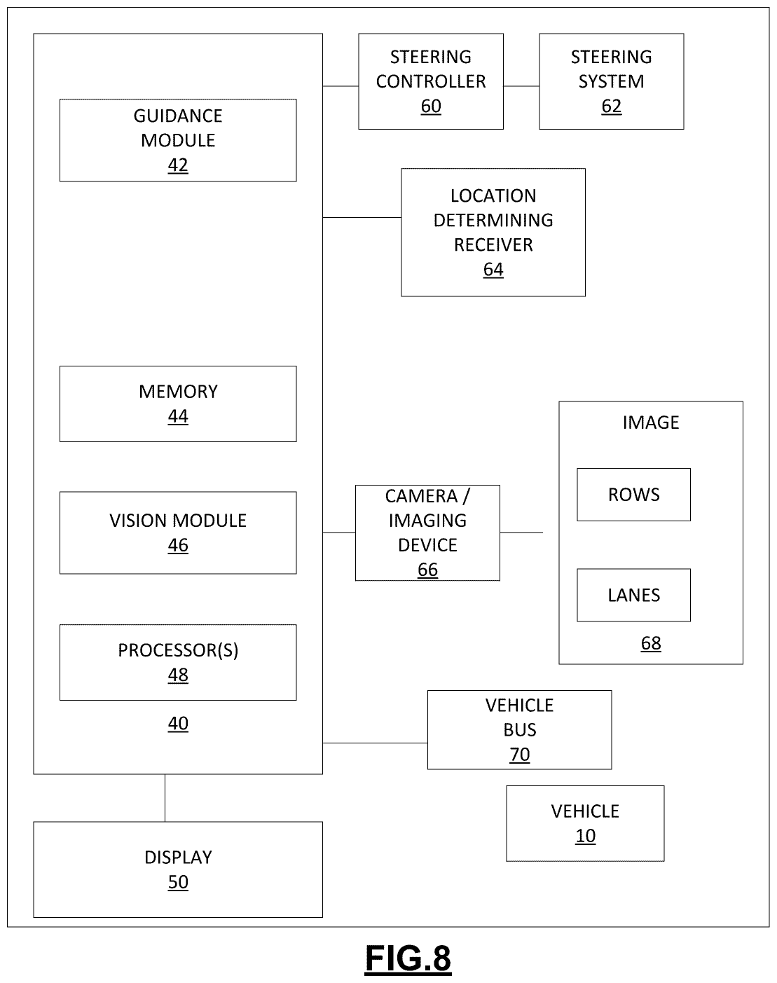

FIG. 8 illustrates one example of a system. As shown in FIG. 8, a vehicle 10 is configured to include a control system 40. The control system 40 includes a guidance module 42 which may be used to generate or access guidance lines and control a steering controller 60 which may in turn control a steering system 62. A location determining receiver 64 such as a GPS receiver may be used by the guidance module 42 to determine vehicle position or associated positions. The control system 40 may be configured to track line-based features across sequential image frames such as using the methods previously described. The control system 40 may be configured to determine guidance lines, identify weed locations, or perform other functions as previously described herein.

A vision module 46 is also shown which may be implemented as a collection of software instructions stored on a machine readable memory 44 which may be executed on one or more processors 48 of the control system 40. The vision module 46 may be self-contained with its own processors and memory or may share resources with other aspects of the control system 40. A display 50 may be operatively connected to the control system 46 and may display imagery such as an image 68 acquired with a camera or other imaging device 66. The display 50 may be used for other purposes as well including to show maps, guidance lines, or other information of interest to an operator. The image 68 may include a representation of multiple rows and lanes in between the rows.

A vehicle bus 70 may also be operatively connected to the control system. Information about equipment being used or control of agricultural vehicles, control of agricultural implements and associated operations, access to vehicle or implement settings, production data, or other information may be communicated through the vehicle bus. In some embodiments, steering may be performed through the vehicle bus 70. Thus, the system may be used for autonomous vehicles, semi-autonomous vehicles, or operator driven vehicles where guidance lines are used either directly by the vehicle or to generate guidance lines which may be displayed to the operator, to determine rows or lanes, or to identify weeds or volunteer plants.

### Options, Variations, and Alternatives

Although primarily discussed in the specific context of agriculture it is to be understood that the methodology shown and described may be used in other contexts as well. In particular, given a camera or other image capture device with any method of image sensing rigidly connected to any device, vehicle, or structure, data from a previous frame may be used to initialize the localization of a feature, series of features or combination of series of features which are then used to calculate a new version of that data but now based on the current frame.

The methodologies and systems described herein are not limited to agricultural applications alone. The principles and techniques described can be advantageously applied to any domain involving visual tracking of linear or curvilinear features in sequential image frames. Examples include autonomous road navigation by tracking lane markings, railway line tracking for rail inspection or autonomous trains, pipeline monitoring using aerial or ground-based imaging platforms, and tracking overhead power or telecommunication cables for maintenance or inspection purposes. The flexibility of the method is particularly advantageous in environments where visual clarity may be periodically compromised due to environmental or atmospheric conditions.

Although linear and polynomial curve fitting is discussed extensively herein, other line-based fitting or feature representation techniques may be equally applicable depending on the use case and desired accuracy, including but not limited to linear regression, spline interpolation, Fourier series approximations, or other numerical optimization techniques. Similarly, image acquisition may employ single or multiple camera setups, stereo vision systems, or sensor fusion approaches combining imaging data with lidar, radar, or ultrasonic sensors to enhance robustness and precision. Additionally, alternative processing strategies, such as employing machine learning or neural network approaches trained to recognize linear features under varying visual conditions, can be utilized either in place of or in conjunction with the described initial estimation methods based on previous best-fit data.

It should also be understood that while linear and polynomial curve fitting methods have been discussed herein, the principles disclosed are not limited to linear or polynomial-based representations. Depending on the accuracy, computational resources, or real-time constraints of a particular application, other mathematical representations or transformations may be employed. Thus, the described method inherently accommodates a wide range of mathematical and computational techniques tailored to the particular environment, type of linear features tracked, and available computational resources.

Moreover, while the camera or imaging device described herein is typically rigidly mounted to a vehicle, the disclosed methods are equally applicable in scenarios where the camera's orientation may dynamically adjust, provided that such adjustments are measurable or predictable. For example, the imaging device may be mounted on a gimbal or actively stabilized platform, and data from position or orientation sensors (such as inertial measurement units or gyroscopes) may be utilized to correct or adjust the best fit line estimates accordingly, further improving tracking accuracy during dynamic movements or challenging operational environments.

The disclosed system may optionally include filtering or smoothing mathematical representations of features across multiple sequential frames. Such filtering or smoothing enhances robustness to transient visual obstructions, variations in lighting, or temporary occlusions, thereby maintaining continuity and improving overall tracking accuracy.

In another alternative, the imaging device frame rate may be dynamically adapted based on vehicle speed, turning radius, or environmental conditions. This ensures effective tracking while balancing computational efficiency and maintaining system responsiveness under varying operational scenarios.

The methods disclosed herein optionally accommodate situations where certain image frames must be skipped or ignored due to poor quality or high noise levels. In such scenarios, stored parameters from previously valid frames may be reused directly, avoiding computational overhead associated with reinitialization.

The system may also incorporate externally generated guidance data, such as lines from previous operations like planting or mapping. These external guidance lines can be transformed into the camera or navigation coordinate space, providing an enhanced initial estimate for feature localization and further improving tracking accuracy.

Optionally, curvature parameters or polynomial coefficients derived from previous frames may be stored explicitly and utilized to predict the trajectories of curvilinear features. This prediction enhances the precision of feature tracking, particularly during vehicle turns or in scenarios involving curves.

Another alternative feature involves identifying undesirable vegetation or anomalies based solely on their spatial relationship to tracked lines, without reliance on appearance-based methods. This spatial identification reduces computational requirements and improves identification accuracy, especially under variable lighting conditions or diverse vegetation types.

It is also contemplated that the methodology may integrate multiple sensing modalities such as color cameras, depth cameras, lidar sensors, radar sensors, or ultrasonic sensors. Combining data from multiple sensors may enhance tracking and/or provide redundancy against individual sensor limitations, and improve performance in visually challenging environments.

It should also be understood the positions of vegetation identified as weeds or other undesirable plants can be systematically cataloged and stored using precise positional data, such as global positioning system (GPS) coordinates. This positional information enables targeted future actions, including mechanical removal, chemical treatment, or alternative weed management practices. By creating and utilizing such a weed position database, agricultural operations can significantly enhance the efficiency, precision, and effectiveness of subsequent field treatments, thereby reducing chemical usage and labor costs while improving crop yield and field health.

It is to be understood that although the methodology has primarily been described using a land-based agricultural vehicle, the methodology may also be applied to aerial drones or other aerial vehicles as well as ground vehicles. Thus, an agricultural field may be traversed by a land-based vehicle traveling through a field or may be traversed by an aerial vehicle traveling over the field.

It should also be understood that although the terms “first”, “second”, and “third” are used, it is to be understood that, for example, where there is a first image frame and a second image frame, there may be any number of intervening image frames between the first image frame and the second image frame. Similarly, there may be any number of intervening image frames between the second image frame and the third image frame.

The disclosure is not to be limited to the particular aspects described herein. In particular, the disclosure contemplates numerous variations in using previous best fit lines as an initialiser. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A method for tracking line-based features across sequential image frames, comprising:
obtaining a first image frame from an imaging device;
identifying, in the first image frame, a plurality of line-based features, wherein the line-based features comprise straight or curved lines;
generating a first mathematical representation of the line-based features in the first image frame;
storing parameters defining the first mathematical representation;
obtaining a second image frame from the imaging device;
utilizing the stored parameters of the first mathematical representation to establish an initial search region for identifying the line-based features in the second image frame;
identifying, in the second image frame, the plurality of line-based features based on the initial search region; and
generating a second mathematical representation of the line-based features in the second image frame.

2. The method of claim 1, wherein the imaging device is mounted on a movable platform.

3. The method of claim 2, wherein the movable platform is a vehicle.

4. The method of claim 3, wherein the vehicle is an agricultural vehicle.

5. The method of claim 4, wherein the line-based features are crop rows in an agricultural field.

6. The method of claim 5, wherein the mathematical representation comprises a best fit line representing a lane between adjacent crop rows.

7. The method of claim 6, further comprising controlling steering of the agricultural vehicle based on the second mathematical representation to navigate the vehicle along the lane between adjacent crop rows.

8. The method of claim 1, wherein generating the first mathematical representation and the second mathematical representation comprises fitting a polynomial curve to the line-based features.

9. The method of claim 1, further comprising:
evaluating image quality of the second image frame based on predefined criteria;
determining whether the second image frame meets the predefined criteria; and
when the second image frame fails to meet the predefined criteria, skipping the second image frame and utilizing the stored parameters for a third image frame.

10. The method of claim 1, further comprising:
identifying objects in the second image frame that are positioned at a distance from the first mathematical representation beyond a predetermined threshold; and
categorizing the identified objects as anomalies.

11. A method for tracking crop rows in agricultural environments, comprising:
obtaining a first image frame from an imaging device mounted on a vehicle;
identifying, in the first image frame, a plurality of crop rows;
generating a first best fit line representing a lane between adjacent crop rows in the first image frame;
storing parameters defining the first best fit line;
obtaining a second image frame from the imaging device;
utilizing the stored parameters of the first best fit line to establish an initial location for identifying crop rows in the second image frame;
identifying, in the second image frame, the plurality of crop rows based on the initial location; and
generating a second best fit line representing the lane between adjacent crop rows in the second image frame.

12. The method of claim 11, wherein the parameters defining the first best fit line comprise coefficients of a polynomial equation.

13. The method of claim 11, further comprising:
tracking multiple lanes simultaneously by generating separate best fit lines for each lane visible in the image frames.

14. The method of claim 11, further comprising:
applying a perspective warp to at least one of the first image frame and the second image frame to generate a bird's eye view of the crop rows.

15. The method of claim 11, further comprising:
controlling steering of the vehicle based on the second best fit line to navigate the vehicle along the lane between adjacent crop rows.

16. A system for visual tracking of crop rows in agricultural environments, comprising:
a vehicle configured to traverse an agricultural field;
an imaging device mounted on the vehicle and configured to capture sequential image frames of crop rows;
a processor communicatively coupled to the imaging device and configured to:
obtain a first image frame from the imaging device;
identify, in the first image frame, a plurality of crop rows;
generate a first best fit line representing a lane between adjacent crop rows in the first image frame;
store parameters defining the first best fit line;
obtain a second image frame from the imaging device;
utilize the stored parameters of the first best fit line to establish an initial location for identifying crop rows in the second image frame;
identify, in the second image frame, the plurality of crop rows based on the initial location; and
generate a second best fit line representing the lane between adjacent crop rows in the second image frame; and
a steering control system configured to guide the vehicle based on the second best fit line.

17. The system of claim 16, wherein the imaging device comprises at least one of:
a color camera, a depth camera, a lidar sensor, or an ultrasonic sensor.

18. The system of claim 16, wherein the processor is further configured to:
filter best fit line data across multiple sequential image frames to improve robustness to missing or degraded frames.

19. The system of claim 16, wherein the processor is further configured to:
maintain tracking of the crop rows during vehicle turns by compensating for changes in apparent position of crop rows within the image frames.

20. The system of claim 16, further comprising:
a spraying system configured to apply treatment to vegetation elements identified as weeds based on their position relative to the best fit line.
